(19) United States
(12) Patent Application Publication
(10) Pub. No.: US 2024/0339710 A1
(43) Pub. Date: Oct. 10, 2024

(54) SEGMENTED BATTERY CELL MOUNTING PLATE FOR THERMAL RUNAWAY MITIGATION

(71) Applicant: GM GLOBAL TECHNOLOGY OPERATIONS LLC, Detroit, MI (US)

(72) Inventors: Ryan P. Hickey, Austin, TX (US); Peter P. Andruskiewicz, IV, Ann Arbor, MI (US)

(73) Assignee: GM GLOBAL TECHNOLOGY OPERATIONS LLC, Detroit, MI (US)

(21) Appl. No.: 18/297,701

(22) Filed: Apr. 10, 2023

(51) Int. Cl. H01M 50/244; H01M 10/6556; H01M 50/103; H01M 50/227; H01M 50/24; H01M 50/249

(52) U.S. Cl. CPC H01M 50/244; H01M 10/6556; H01M 50/103; H01M 50/227; H01M 50/24; H01M 50/249; H01M 2220/20

(57) ABSTRACT

A battery module includes first and second neighboring battery cells and a mounting plate configured to support the battery cells. The battery module additionally includes an enclosure surrounded by an ambient environment and configured to house the first and second battery cells arranged on the mounting plate. The mounting plate includes a first segment configured to support the first battery cell and a second segment configured to support the second battery cell. The first segment is connected to the second segment via an interface having mechanical strength lower than mechanical strength of each of the first and second segments. The interface is configured to fracture when the first battery cell undergoes a thermal event and separate the first segment from the second segment to exhaust gases from the first battery cell away from the second battery cell, thereby controlling propagation of a thermal runaway in the battery module.

### INTRODUCTION

The present disclosure relates to a segmented design battery cell mounting plate for thermal runaway mitigation in a battery module.

A battery module or array may include a plurality of battery cells in relatively close proximity to one another. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Such chemical reactions may cause more heat to be generated by the batteries than is effectively withdrawn. Exposure of a battery cell to elevated temperatures over prolonged periods may cause the cell to experience a thermal runaway event. Accordingly, a thermal runaway event starting within an individual cell may lead to the heat spreading to adjacent cells in the module and cause the thermal runaway event to affect the entire battery array.

### SUMMARY

A battery module includes first and second neighboring battery cells. The battery module also includes a mounting plate configured to support each of the first battery cell and the second battery cell. The battery module additionally includes a battery module enclosure surrounded by an ambient environment and configured to house each of the first and second battery cells arranged on the mounting plate. The mounting plate includes a first segment configured to support the first battery cell and a second segment configured to support the second battery cell. The first segment is connected to the second segment via an interface having mechanical strength lower than mechanical strength of each of the first and second segments. The interface is configured to fracture in response to the first battery cell undergoing a thermal event and separate the first segment from the second segment to exhaust gases from the first battery cell into a space between the mounting plate and the battery module enclosure. Thermal energy from the first battery cell is thereby transferred away from the second battery cell to mitigate or control propagation of a thermal runaway in the battery module.

The mounting plate may include each of the interface, the first segment, and the second segment and may be defined by a continuous unitary structure constructed from a single material.

The material of the mounting plate may be a nylon-based polymer.

The interface may be defined by a pre-score, e.g., an indentation or a crease, in the mounting plate generating a reduced material thickness in a cross-sectional view between the first and second segments.

At least one of the first and second segments may include multiple individual tiles defined by corresponding pre-scores therebetween.

Each of the first and second segments may have an interlinking shape.

The first battery cell and the second battery cell may be attached to the respective first and second segments via an adhesive.

The battery module may additionally include a coolant header arranged in the battery module enclosure and configured to remove thermal energy from the first and second battery cells.

The coolant header may include ribbon-shape coolant channels configured to seat and retain the first and second battery cells.

Each of the first and second battery cells may have either a cylindrical or a prismatic cell construction.

A motor vehicle having a power-source and the above-disclosed battery module configured to supply electric energy to the power-source is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a battery module having a plurality of battery cells configured to generate and store electrical energy, according to the disclosure.

FIG. 2 is a schematic close-up cross-sectional partial side view of the battery module shown in FIG. 1, specifically depicting a plurality of battery cells organized in rows, a cooling subsystem for removing thermal energy from the battery cells, a segmented mounting plate supporting individual battery cells, and one of the battery cells experiencing a thermal event with a resultant fracturing of the segments at corresponding interfaces between individual tiles, according to the disclosure.

FIG. 3 is a schematic top view of the battery system including the cooling subsystem shown in FIG. 2, having a ribbon-shape coolant header enfolding individual rows of battery cells.

FIG. 4 is a schematic top view of the segmented mounting plate shown in FIG. 2, specifically depicting mounting plate segments including multiple tiles connected via corresponding interfaces, according to the disclosure.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

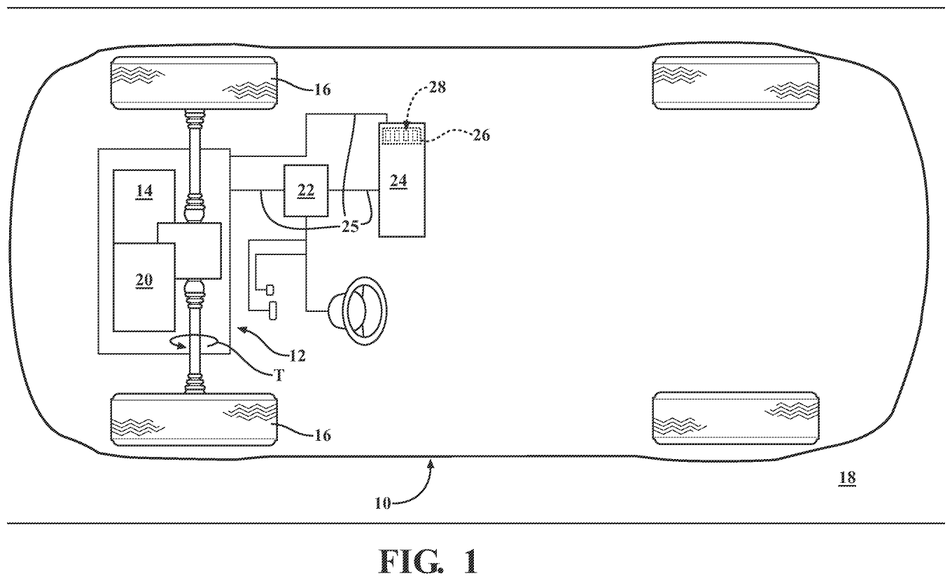

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may also include an additional power-source 20, such as an internal combustion engine. The power-sources 14 and 20 may act in concert to power the vehicle 10. The vehicle 10 additionally includes an electronic controller 22 and a battery system 24 configured to store and discharge electrical energy through heat-producing electro-chemical reactions for supplying the electrical energy to the power-sources 14 and 20. The electronic controller 22 may be a central processing unit (CPU) that regulates various functions on the vehicle 10, or as a powertrain control module (PCM) configured to control the powertrain 12 to generate a predetermined amount of power-source torque T. The battery system 24 may be connected to the power-sources 14 and 20, the electronic controller 22, as well as other vehicle systems via a high-voltage BUS 25. The battery system 24 may include one or more sections, such as a battery array or module 26 having battery cells 28.

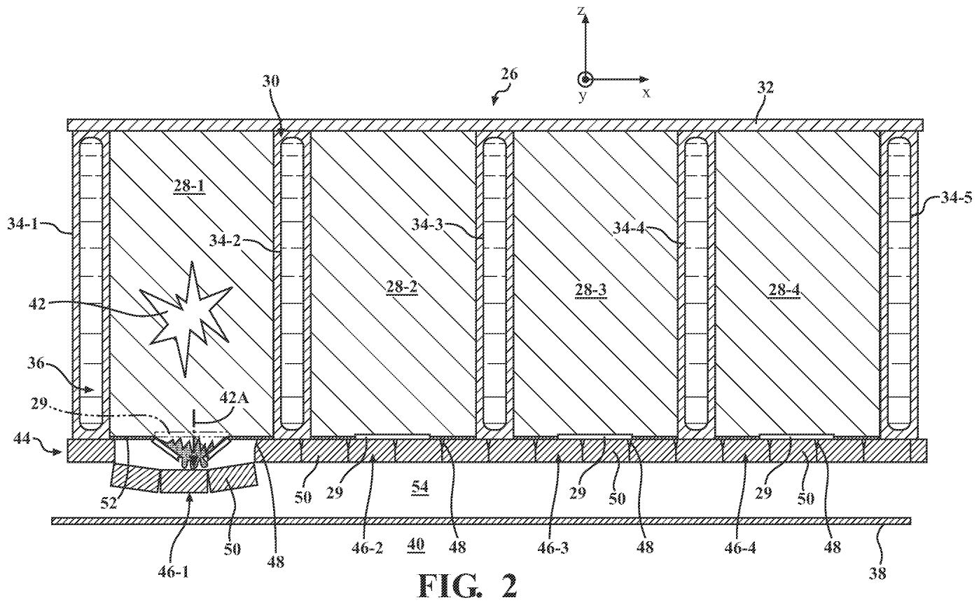

As shown in FIG. 2, each battery module 26 includes a plurality of battery cells, such as a first battery cell 28-1 and a neighboring, directly adjacent, second battery cell 28-2, as well as third and fourth battery cells 28-3 and 28-4. Each of the battery cells 28-1. 28-2, 28-3, 28-4 may have a cylindrical or a prismatic cell construction, extending generally upward along the Z axis, specifically shown in the X-Z plane. Each of the subject battery cells 28-1, 28-2, 28-3, 28-4 may have a dedicated cell vent 29. As shown, each of the four battery cells 28-1, 28-2, 28-3, 28-4 is a constituent cell in an individual row of battery cells of the module 26. Each row in the module 26 may have a quantity of battery cells required for a particular application of the battery system 24. Although one module 26 and four battery cell rows are shown, nothing precludes the battery system 24 from having a greater number of modules and fewer or greater number of battery cell rows in each module.

As shown in FIG. 2, the battery system 24 also includes a cooling subsystem 30 configured to remove thermal energy from the battery cells 28-1, 28-2, 28-3, 28-4. The cooling subsystem 30 includes a coolant header 32 operating as a heat sink for the battery cells 28-1, 28-2, 28-3, 28-4. The coolant header 32 includes individual coolant passages, such as passages 34-1, 34-2, 34-3, 34-4, and 34-5 shown in FIG. 2, extending proximate the battery cells 28-1, 28-2, 28-3, 28-4. The passages 34-1, 34-2, 34-3, 34-4, and 34-5 are configured to circulate a coolant 36 through the coolant header 32. The coolant header 32 may be fluidly connected to an external source of the coolant 36, such as a fluid pump (not shown).

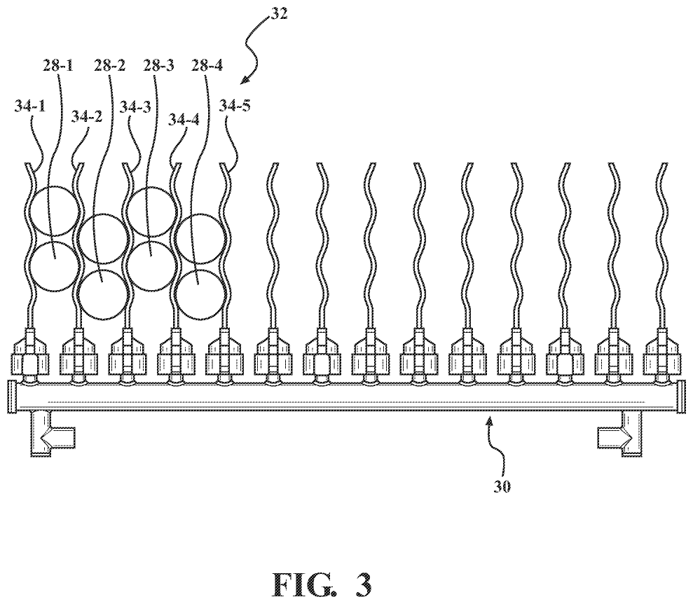

Each pair of passages, such as passages 34-1 and 34-2, passages 34-2 and 34-3, passages 34-3 and 34-4, and passages 34-4 and 34-5, is intended to be in contact with and sandwich one row of battery cells, such as an individual row including one of the corresponding battery cells 28-1, 28-2, 28-3, 28-4, and thereby configured to absorb and remove thermal energy therefrom. The passages 34-1, 34-2, 34-3, 34-4, and 34-5 of the coolant header 32 may have a wave-like ribbon shape, as shown in a top view in FIG. 3. Such ribbon shape of adjacent passages 34-1, 34-2, 34-3, 34-4, and 34-5 is configured to generally enfold individual rows of battery cells of the module 26. As a result, the ribbon-shaped passages 34-1, 34-2, 34-3, 34-4, 34-5 are generally configured to seat the battery cells 28-1, 28-2, 28-3, 28-4 in individually sandwiched rows and maintain their positions relative to one another. As shown in FIG. 2, the battery system 24 also includes a battery module enclosure 38 surrounded by an external or ambient environment 40. The battery module enclosure 38 may include a battery tray and a mating battery enclosure cover (not shown), together configured to house the battery cells of the module 26 and the coolant header 32.

Generally, during typical charge/discharge operation of the module 26, the cooling subsystem 30 is effective in absorbing thermal energy released by the rows of battery cells including the cells 28-1, 28-2, 28-3, 28-4 and facilitating transfer of the thermal energy to the ambient environment 40. However, during extreme conditions, such as during a thermal runaway event (identified via numeral 42 in FIG. 2), the amount of thermal energy released by the cell undergoing the event will typically saturate the coolant header 32 and exceed its capacity to absorb and efficiently transfer heat out of the battery module 26. As a result, excess thermal energy will typically be transferred to other battery cells in the corresponding cell row and to cells in neighboring rows, leading to propagation of the thermal runaway through the module 26. The term “thermal runaway” generally refers to an uncontrolled increase in temperature in a battery system. During a thermal runaway, the generation of heat within a battery system or a battery cell exceeds the dissipation of heat, thus leading to a further increase in temperature. A thermal event in a battery cell leading to a thermal runaway in the battery system may be triggered by various conditions, including a short circuit within the cell, improper cell use, physical abuse, manufacturing defects, or exposure of the cell to extreme external temperatures.

With resumed reference to FIG. 2, the battery system 24 also includes a mounting plate 44. The mounting plate 44 is configured to support each of the battery cells rows of the module 26, including the cells 28-1, 28-2, 28-3, and 28-4. The mounting plate 44 includes a first segment 46-1 configured to support the first battery cell 28-1, a second segment 46-2 configured to support the second battery cell 28-2, as well third and fourth segments 46-3, 46-4 configured to support respective third and fourth battery cells 28-3, 28-4. Each segment is interconnected with other segments in the mounting plate 44, either directly or by means of intermediate segments, via boundary sections or interfaces 48. Specifically, the first segment 46-1 is connected to the second segment 46-2 via at least one corresponding interface 48. The mechanical strength of the interface 48 is lower than the mechanical strength of each of the first and second segments 46-1, 46-2.

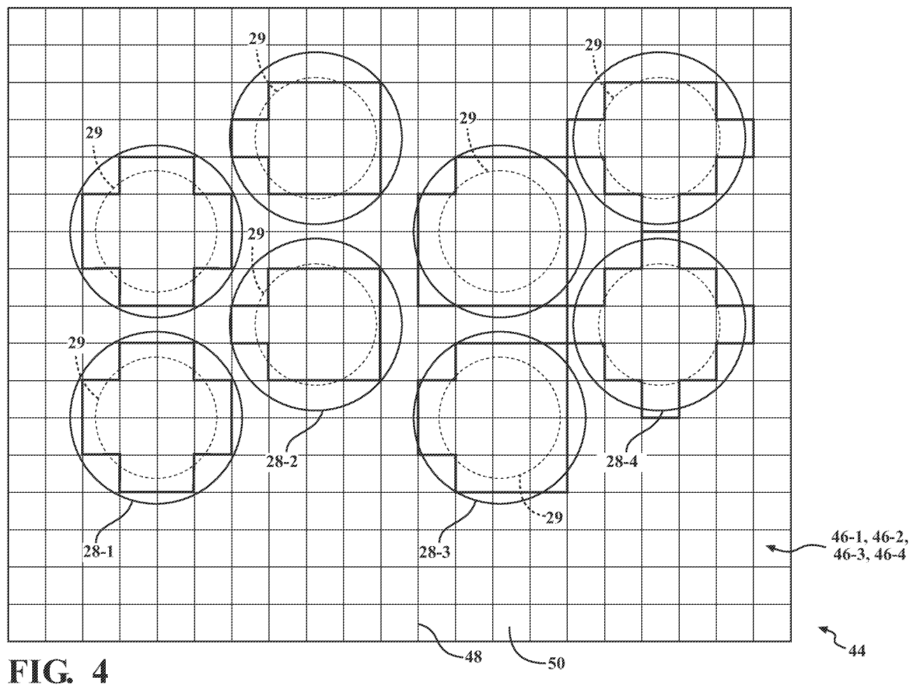

The mounting plate 44, including each of the individual segments 46-1, 46-2, 46-3, 46-4 and the interfaces 48 therebetween, may be defined by a continuous unitary structure constructed from a single material having a particular microstructure. The mounting plate 44 may be constructed from a relatively low-thermal conductivity material configured to minimize transfer of heat between battery cells 28-1, 28-2, 28-3, 28-4 during a thermal runaway event. For example, the material of the mounting plate 44 may be a nylon-based polymer. Each interface 48 may be defined by a pre-score, such as an indentation or a crease, in the mounting plate 44 structure, thereby generating a reduced material thickness between corresponding segments, such as the first and second segments 46-1 and 46-2, in a cross-sectional view shown in FIG. 2. As shown in FIG. 4, at least one of the individual segments, such as the first and second segments 46-1, 46-2, may include multiple individual tiles 50 defined by corresponding pre-scores 48 therebetween.

The respective battery cells, such as the cells 28-1, 28-2, 28-3, 28-4, are not required to be aligned or otherwise specifically arranged with the individual segments, e.g., first and second segments 46-1, 46-2, or the respective tiles 50. Each of the individual segments 46-1, 46-2, 46-3, 46-4, as well as each of the constituent tiles 50, may have an interlinking or interconnecting shape, such that individual segment sides mesh with sides of neighboring segments. As shown in FIG. 4, the interlinking shape may be a square, however, other repeating interlinking shapes, such as triangles, hexagons, etc. may also be used. Individual battery cells 28-1, 28-2, 28-3, 28-4 may be attached, i.e., glued, to the respective segments 46-1, 46-2, 46-3, 46-4 along the battery casing lower surface proximate the cell vent 29 via an adhesive 52.

Each interface 48 is configured to fracture and permit separation of adjacent mounting plate segments 46-1, 46-2, 46-3, 46-4 and/or constituent tiles 50 in response to a battery cell experiencing a respective thermal event supported by a corresponding segment. For example, as shown in FIG. 2, the interface 48 between segments 46-1 and 46-2 may fracture under the force of gases 42A and debris emitted through the cell vent 29 when the first battery cell 28-1 undergoes a thermal event. As a result, the first segment 46-1 would separate from the second segment 46-2 and detach from the mounting plate 44. The consequent opening in the mounting plate 44 would permit gases 42A and debris from the affected first battery cell 28-1 to be exhausted into a space or airgap 54 between the mounting plate and the battery module enclosure 38.

Accordingly, excess thermal energy emitted by the first battery cell 28-1 would thus be diverted away from the other battery cells 28-2, 28-3, and 28-4. Such transfer of the affected battery cell's excess thermal energy away from other battery cells is intended to control or mitigate propagation of the thermal runaway 42 in the battery module 26. Additionally. since the respective battery cells 28-1, 28-2, 28-3, 28-4 are not specifically aligned with individual tiles 50 or the corresponding segments, 46-1, 46-2, a thermal event 42 in one cell may break out a random number of tiles to release respective gases 42A and debris into the airgap 54 without negatively impacting mounting plate 44 support for an adjacent battery cell.

Overall, the segmented mounting plate 44 enables secure mounting of individual battery cells, such as the cells 28-1, 28-2, 28-3, 28-4, in the battery module enclosure 38 for normal charge/discharge operation of the battery module 26. However, when one of the module's battery cells undergoes a thermal event, under the pressure of emitted gases 42A, the individual segment(s) supporting the subject cell will separate at corresponding interfaces 48 from the neighboring segments supporting adjacent cells to exhaust the affected battery cell gases and/or debris away from other cells. By transferring the cell gases 42A and/or debris through the generated opening in the segmented mounting plate 44, the emitted thermal energy may be diverted to the ambient environment without adversely affecting other battery cells, thus mitigating propagation of thermal runaway in the battery module 26.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A battery module comprising:
a first battery cell and a neighboring second battery cell;
a mounting plate configured to support each of the first battery cell and the second battery cell; and
a battery module enclosure surrounded by an ambient environment and configured to house each of the first and second battery cells arranged on the mounting plate;
wherein:
the mounting plate includes a first segment configured to support the first battery cell and a second segment configured to support the second battery cell;
the first segment is connected to the second segment via an interface having mechanical strength lower than mechanical strength of each of the first and second segments; and
the interface is configured to fracture in response to the first battery cell undergoing a thermal event and separate the first segment from the second segment to exhaust gases from the first battery cell into a space between the mounting plate and the battery module enclosure to thereby transfer thermal energy from the first battery cell away from the second battery cell and control propagation of a thermal runaway in the battery module.

2. The battery module of claim 1, wherein the mounting plate, including each of the interface, the first segment, and the second segment, is defined by a continuous unitary structure constructed from a single material.

3. The battery module of claim 2, wherein the material of the mounting plate is a nylon-based polymer.

4. The battery module of claim 1, wherein the interface is defined by a pre-score in the mounting plate generating a reduced material thickness in a cross-sectional view between the first and second segments.

5. The battery module of claim 4, wherein at least one of the first and second segments includes multiple individual tiles defined by corresponding pre-scores therebetween.

6. The battery module of claim 1, wherein each of the first and second segments has an interlinking shape.

7. The battery module of claim 1, wherein the first battery cell and the second battery cell are attached to the respective first and second segments via an adhesive.

8. The battery module of claim 1, further comprising a coolant header arranged in the battery module enclosure and configured to remove thermal energy from the first and second battery cells.

9. The battery module of claim 8, wherein the coolant header includes ribbon-shape coolant channels configured to seat and retain the first and second battery cells.

10. The battery module of claim 1, wherein each of the first and second battery cells has one of a cylindrical and a prismatic cell construction.

11. A motor vehicle comprising:
a power-source configured to generate power-source torque; and
a battery module configured to supply electrical energy to the power-source, the battery module including:
a first battery cell and a neighboring second battery cell;
a mounting plate configured to support each of the first battery cell and the second battery cell; and
a battery module enclosure surrounded by an ambient environment and configured to house each of the first and second battery cells arranged on the mounting plate;
wherein:
the mounting plate includes a first segment configured to support the first battery cell and a second segment configured to support the second battery cell;
the first segment is connected to the second segment via an interface having mechanical strength lower than mechanical strength of each of the first and second segments; and
the interface is configured to fracture in response to the first battery cell undergoing a thermal event and separate the first segment from the second segment to exhaust gases from the first battery cell into a space between the mounting plate and the battery module enclosure to thereby transfer thermal energy from the first battery cell away from the second battery cell and control propagation of a thermal runaway in the battery module.

12. The motor vehicle of claim 11, wherein the mounting plate, including each of the interface, the first segment, and the second segment, is defined by a continuous unitary structure constructed from a single material.

13. The motor vehicle of claim 12, wherein the material of the mounting plate is a nylon-based polymer.

14. The motor vehicle of claim 11, wherein the interface is defined by a pre-score in the mounting plate generating a reduced material thickness in a cross-sectional view between the first and second segments.

15. The motor vehicle of claim 14, wherein at least one of the first and second segments includes multiple individual tiles defined by corresponding pre-scores therebetween.

16. The motor vehicle of claim 11, wherein each of the first and second segments has an interlinking shape.

17. The motor vehicle of claim 11, wherein the first battery cell and the second battery cell are attached to the respective first and second segments via an adhesive.

18. The motor vehicle of claim 11, wherein the battery module additionally includes a coolant header arranged in the battery module enclosure and configured to remove thermal energy from the first and second battery cells.

19. The battery module motor vehicle of claim 18, wherein the coolant header includes ribbon-shape coolant channels configured to seat and retain the first and second battery cells.

20. A battery module comprising:
a first battery cell and a neighboring second battery cell;
a mounting plate configured to support each of the first battery cell and the second battery cell; and
a battery module enclosure surrounded by an ambient environment and configured to house each of the first and second battery cells arranged on the mounting plate;
wherein:
the mounting plate includes a first segment configured to support the first battery cell and a second segment configured to support the second battery cell;
the first battery cell and the second battery cell are attached to the respective first and second segments via an adhesive;
the first segment is connected to the second segment via an interface having mechanical strength lower than mechanical strength of each of the first and second segments;
the interface is defined by a pre-score in the mounting plate generating a reduced material thickness in a cross-sectional view between the first and second segments; and
the interface is configured to fracture in response to the first battery cell undergoing a thermal event and separate the first segment from the second segment to exhaust gases from the first battery cell into a space between the mounting plate and the battery module enclosure to thereby transfer thermal energy from the first battery cell away from the second battery cell and control propagation of a thermal runaway in the battery module.
